(19) United States
(12) Patent Application Publication
(10) Pub. No.: US 2017/0116731 A1
(43) Pub. Date: Apr. 27, 2017

(54) MEDICAL IMAGE SYSTEM AND COMPUTER READABLE RECORDING MEDIUM

(71) Applicant: Konica Minolta, Inc., Tokyo (JP)

(72) Inventors: Akinori TSUNOMORI, Tokyo (JP); Hirotake MINAMI, Tokyo (JP)

(21) Appl. No.: 15/297,632

(22) Filed: Oct. 19, 2016

(30) Foreign Application Priority Data
Oct. 27, 2015 (JP) 2015-210302
Aug. 31, 2016 (JP) 2016-168826

(51) Int. Cl. G06T 7/00; G06T 5/00

(52) U.S. Cl. CPC G06T 7/0012; G06T 7/0081; G06T 5/002; G06T 2207/10116; G06T 2207/30068

(57) ABSTRACT

A medical image system, including: a target region extraction section which extracts a target region from a medical image obtained by X-ray imaging of a target site; a first extraction section which extracts an initial region from the target region, the initial region having a brightness value which is equal to or larger than a first reference value; a second extraction section which extracts a region having a brightness value that is equal to or smaller than a second reference value from a region including the initial region in the target region; an acquisition section which calculates areas of the target region, the region including the initial region and the region extracted by the second extraction section, and acquires an index regarding a lesion based on the calculated areas; and a display section which displays the acquired index regarding the lesion.

### CROSS-REFERENCE TO RELATED APPLICATIONS

The entire disclosure of Japanese Patent Application No. 2015-210302 filed on Oct. 27, 2015, and Japanese Patent Application No. 2016-168826 filed on Aug. 31, 2016, including descriptions, claims, drawings and abstracts are incorporated herein by reference in its entirety.

### BACKGROUND OF THE INVENTION

Field of the Invention

The present invention relates to a medical image system and a computer readable recording medium.

Description of Related Art

Mammography screening has been widely used for breast cancer screening. Minute lesions can be detected from mammographic images (hereinafter, merely referred to as breast images) which were obtained in the mammography screening. However, since mammary gland regions are expressed with brightness values of same degrees as those of lesions (tumor masses), there is a possibility that the lesions are not found in a case where patients have high density mammary glands. Thus, in recent years, additional examinations such as ultrasonography have been recommended for patients having high density mammary glands.

Whether to perform an additional examination, that is, whether the patient is at a high risk of having a lesion not found is generally determined by subjective evaluation which is visually performed by a doctor. Generally, the evaluation is performed on the basis of the following criteria (1) and (2).

(1) Ratio of mammary gland region to breast region in breast image (mammary gland content rate)

(2) Ratio of fat region in mammary gland region to mammary gland region in breast image

Unfortunately, studies have found that the evaluation results are not the same between doctors or at different times even by a same doctor since the above evaluation is visually performed in a qualitative manner.

For example, Patent document 1 (Japanese Patent Application Laid Open Publication No. 2010-253245) describes calculating a mammary gland content rate on the basis of a breast image, pixel values of void region estimated from the breast image and a fat image in order to accurately grasp the condition of breast.

However, the Patent document 1 does not mention the criterion (2) among the above criteria (1) and (2). Furthermore, the doctor estimates the mammary gland content rate for a concept different from the concept of determining the necessity of additional examination. Thus, it is concerned that the criterion is not compatible with the doctor's determination in a case where the mammary gland content rate is used as a determination criterion of a lesion missing risk.

### SUMMARY OF THE INVENTION

An object of the present invention is to provide an index indicating a lesion missing risk which is objective and compatible with conventional methods for determining a lesion missing risk by a doctor.

In order to achieve at least one of the above objects, according to one aspect of the present invention, there is provided a medical image system, including: a target region extraction section which extracts a target region from a medical image obtained by X-ray imaging of a target site; a first extraction section which extracts an initial region from the target region, the initial region having a brightness value which is equal to or larger than a first reference value; a second extraction section which extracts a region having a brightness value that is equal to or smaller than a second reference value from a region including the initial region in the target region; an acquisition section which calculates areas of the target region, the region including the initial region and the region extracted by the second extraction section, and acquires an index regarding a lesion based on the calculated areas; and a display section which displays the acquired index regarding the lesion.

According to another aspect of the present invention, there is provided a non-transitory computer readable recording medium storing a program to cause a computer to function as: a target region extraction section which extracts a target region from a medical image obtained by X-ray imaging of a target site; a first extraction section which extracts an initial region from the target region, the initial region having a brightness value which is equal to or larger than a first reference value; a second extraction section which extracts a region having a brightness value that is equal to or smaller than a second reference value from a region including the initial region in the target region; an acquisition section which calculates areas of the target region, the region including the initial region and the region extracted by the second extraction section, and acquires an index regarding a lesion based on the calculated areas; and a display section which displays the acquired index regarding the lesion.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a view showing an example of the entire configuration of a medical image system in an embodiment;

FIG. 2 is a block diagram showing a functional configuration of an image processing apparatus in FIG. 1;

FIG. 3 is a block diagram showing a functional configuration of an image display apparatus in FIG. 1;

FIG. 4 is a flowchart showing lesion missing risk information acquisition processing executed by a control section in FIG. 2;

FIG. 5 is a flowchart showing breast region extraction processing executed in step S1 of FIG. 4;

FIG. 6A is a view for explaining a determination method of a search start point of pectoralis major muscle line;

FIG. 6B is a view for explaining a detection method of the pectoralis major muscle line;

FIG. 7 is a view for explaining a method of removing a lower part of the breast;

FIG. 8 is a flowchart showing mammary gland region extraction processing executed in step S2 of FIG. 4;

FIG. 9A is a view showing an example of initial mammary gland region which is removed as noise;

FIG. 9B is a view showing an example of initial mammary gland region which is removed as noise;

FIG. 9C is a view showing an example of initial mammary gland region which is not removed as noise;

FIG. 10 is a view for explaining filling processing;

FIG. 11 is a view for explaining merging processing;

FIG. 12 is a view showing an initial mammary gland region and a mammary gland region after the merging processing;

FIG. 13 is a view for explaining a method of acquiring a score indicating a lesion missing risk;

FIG. 14A is a view showing an example of a display manner of an index showing the lesion missing risk;

FIG. 14B is a view showing an example of a display manner of an index showing the lesion missing risk;

FIG. 14C is a view showing an example of a display manner of an index showing the lesion missing risk;

FIG. 15 is a flowchart showing parameter adjustment processing executed in the image display apparatus and the image processing apparatus in FIG. 1;

FIG. 16A is a view showing an example of a parameter adjustment screen;

FIG. 16B is a view showing an example of a parameter adjustment screen;

FIG. 17A is a view showing transmission and reception of information between the apparatuses in the embodiment; and

FIG. 17B is a view showing transmission and reception of information between the apparatuses in a modification example.

### DETAILED DESCRIPTION OF THE PREFERRED EMBODIMENT

### Configuration of Medical Image System 100

First, a configuration of an embodiment will be described.

FIG. 1 shows a system configuration example of a medical image system 100 in the embodiment.

As shown in FIG. 1, the medical image system 100 is configured by including an image generation apparatus 1, an image processing apparatus 2 and an image display apparatus 3. These apparatuses 1 to 3 are connected to each other so as to transmit and receive data therebetween via a communication network N such as a LAN (Local Area Network) established in a medical facility. The DICOM (Digital Imaging and Communication in Medicine) standard is applied to the communication network N. The number of each of the apparatuses is not especially limited.

In the medical image system 100, an index regarding a lesion is acquired on the basis of the medical image which was acquired by X-ray imaging of a target site, and the acquired index is displayed together with the medical image. Though the medical image system 100 treats medical images of various target sites, the embodiment is described here by taking, as an example, a case where X-ray imaging is performed to a breast, an index indicating a lesion missing risk when reading the acquired breast image is acquired and the acquired index is displayed together with the breast image.

Hereinafter, each of the apparatuses 1 to 3 will be described.

The image generation apparatus 1 is an X-ray imaging apparatus which performs X-ray imaging of a target site in a human body, and generates digital data of the captured image (medical image). Modalities such as CR (Computed Radiography) apparatus and FPD (Flat Panel Detector) apparatus can be applied, for example. In the embodiment, an FPD apparatus which performs X-ray imaging of left and right breasts is applied as the image generation apparatus 1, and data of each of the breast images is generated as the medical image. The pixel values of the breast image generated by the image generation apparatus 1 are brightness values and increased as the absorption of X-ray by the subject is larger. The pixel on the breast image is expressed to be whiter as the pixel value is larger.

The image generation apparatus 1 meets the above-mentioned DICOM standard, and can allow a user to input, from outside, various information such as patient information and examination information which is to be attached to each of the generated breast images, and can also automatically generate the information. The patient information includes patient identification information (for example, patient ID) for identifying a patient (subject), a patient name, sex, birth date and such like. The examination information includes examination identification information (for example, examination ID) for identifying examination, date and time of examination, examination condition (examined site, laterality (left or right), direction (for example, vertical direction (CC) and oblique direction (MLO)), modality type and such like. In the embodiment, a same examination ID is provided for management to a series of breast images (two left and right MLO images (LMLO and RMLO) and two left and right CC images (LCC and RCC)) which were acquired by mammography screening to a same patient. The image generation apparatus 1 adds the above patient information, examination information, UID (Unique ID) for identifying an image and such like as header information to the generated breast image and transmit them to the image processing apparatus 2 and the image display apparatus 3 via the communication network N. In a case where the image generation apparatus 1 is not based on the DICOM standard, a DICOM conversion apparatus not shown in the drawings may be used for input of the accompanying information in the image generation apparatus 1.

The image processing apparatus 2 is a medical image processing apparatus which acquires an index indicating a lesion missing risk when reading a breast image on the basis of the breast image transmitted from the image generation apparatus 1, attaches the patient information, examination information, UID and such like as the header information of the breast image to the acquired index, and transmits them as the lesion missing risk information to the image display apparatus 3.

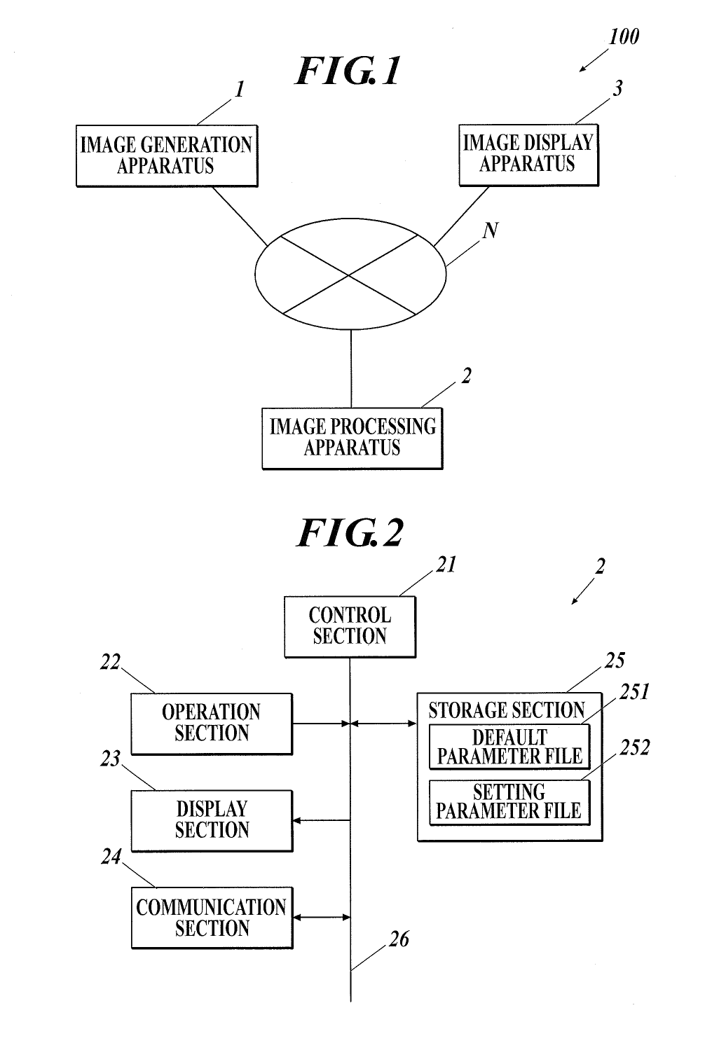

FIG. 2 shows a functional configuration example of the image processing apparatus 2.

As shown in FIG. 2, the image processing apparatus 2 is configured by including a control section 21, an operation section 22, a display section 23, a communication section 24 and a storage section 25, and the above sections are connected to each other via a bus 26.

The control section 21 is configured by including a CPU (Central Processing Unit), a RAM (Random Access Memory) and such like. The CPU of the control section 21 functions as a target region extraction section, a first extraction section, a second extraction section, an acquisition section and noise removal section by reading out various programs such as system programs and processing programs stored in the storage section 25, loading the programs into the RAM and executing various types of processing in accordance with the loaded programs.

The operation section 22 is configured by including a keyboard including character input keys, numeric keys and various types of function keys, and a pointing device such as a mouse. The operation section 22 outputs a press signal of a key pressed on the keyboard and an operation signal by a mouse as input signals to the control section 21.

The display section 23 is configured by including a monitor such as a CRT (Cathode Ray Tube) and an LCD (Liquid Crystal Display), for example, and displays various screens in accordance with instructions of display signals input from the control section 21.

The communication section 24 is configured by including a LAN card and such like, and transmits and receives data to and from external equipment connected to the communication network N via a switching hub.

The storage section 25 is configured by including a nonvolatile memory such as an HDD (Hard Disk Drive) and a semiconductor, for example. The storage section 25 stores various programs as mentioned above. The storage section 25 stores a default parameter file 251, a setting parameter file 252 and such like.

The default parameter file 251 is a file for storing default values of a mammary gland region extraction parameter, a fat region (in mammary gland region) extraction parameter and a score determination parameter which are used in after-mentioned lesion missing risk information acquisition processing.

The setting parameter file 252 is a file for storing setting values of the mammary gland region extraction parameter, fat region extraction parameter and score determination parameter which are used in after-mentioned lesion missing risk information acquisition processing, and the setting values are specific to facility. In the setting parameter file 252, a default value is stored as an initial value, and the value is updated to a set value when after-mentioned parameter adjustment processing is executed.

The image display apparatus 3 is a display section which stores the breast image transmitted from the image generation apparatus 1 and the lesion missing risk information transmitted from the image processing apparatus 2 so as to be associated with each other, and displays the breast image and the index indicating the lesion missing risk of the breast image according to user's request.

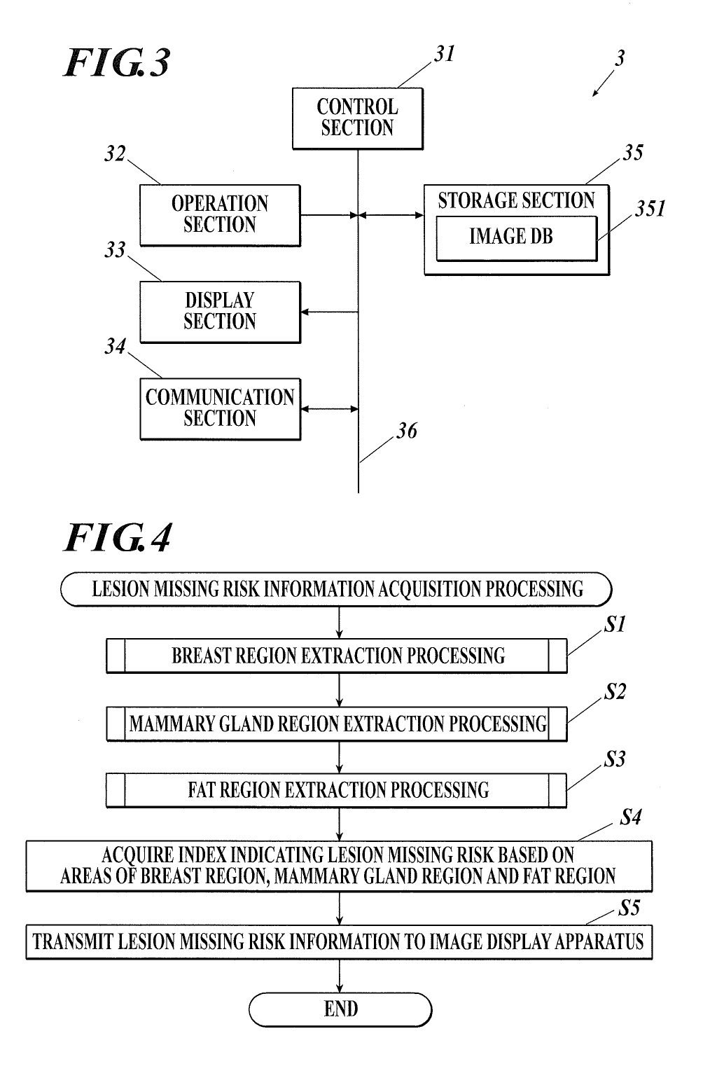

FIG. 3 shows a function configuration example of the image display apparatus 3.

As shown in FIG. 3, the image display apparatus 3 is configured by including a control section 31, an operation section 32, a display section 33, a communication section 34 and a storage section 35, and the above sections are connected to each other via a bus 36.

The control section 31 is configured by including a CPU, a RAM and such like. The CPU of the control section 31 reads out various programs such as system programs and processing programs stored in the storage section 35, loads the programs into the RAM, and executers various types of processing in accordance with the loaded programs.

The operation section 32 is configured by including a keyboard including character keys, numeric keys, various function keys and such like, and a pointing device such as a mouse. The operation section 32 outputs a press signal of a key pressed on the keyboard and an operation signal of a mouse as input signals to the control section 31.

The display section 33 is configured by including a monitor such as a CRT (Cathode Ray Tube) and an LCD (Liquid Crystal Display), for example, and displays various screens in accordance with instructions of display signals input from the control section 31.

The communication section 34 is configured by including a LAN card and such like, and transmits and receives data to and from external equipment connected to the communication network N via a switching hub.

The storage section 35 is configured by including a nonvolatile memory such as an HDD (Hard Disk Drive) and a semiconductor, for example. The storage section 35 stores system programs and various programs as mentioned above.

An image DB (database) 351 is provided in the storage section 35. The image DB 351 stores the breast image transmitted from the image generation apparatus 1 and the lesion missing risk information transmitted from the image processing apparatus 2 so as to be associated with each other.

### Operation of Medical Image System 100

Next, an operation of the medical image system 100 will be described.

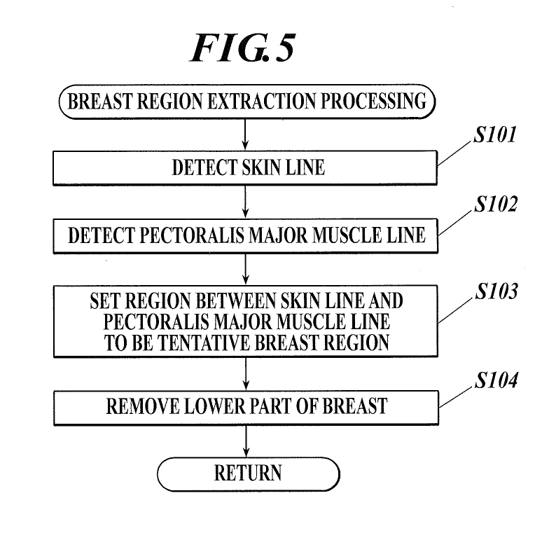

FIG. 4 shows a flowchart of lesion missing risk information acquisition processing executed when the breast image is received from the image generation apparatus 1 by the communication section 24 in the image processing apparatus 2. The lesion missing risk information acquisition processing is executed by cooperation between the control section 21 and the program stored in the storage section 25.

First, the control section 21 performs breast region extraction processing to the received breast image (step S1).

FIG. 5 shows a flowchart of the breast region extraction processing. The breast region extraction processing is executed by cooperation between the control section 21 and the program stored in the storage section 25.

In the breast region extraction processing, the control section 21 first detects a skin line (step S101).

The skin line detection can be performed by using a known method. For example, the U.S. Pat. No. 5,353,149 describes using a predetermined threshold to binarize the pixel values of breast image and divide the values into low brightness region and high brightness region, deleting, from the divided high brightness region, a high brightness region reaching the image end opposite to the chest wall side in the breast image, repeating the deletion by increasing the threshold value until the high brightness region remains, and detecting the outline of the remaining high brightness region as the skin line SL. Thus, the breast region can be accurately detected even under the influence of heel effect.

Next, the control section 21 detects a pectoralis major muscle line (step S102).

The detection of pectoralis major muscle line L can be performed by the following method, for example.

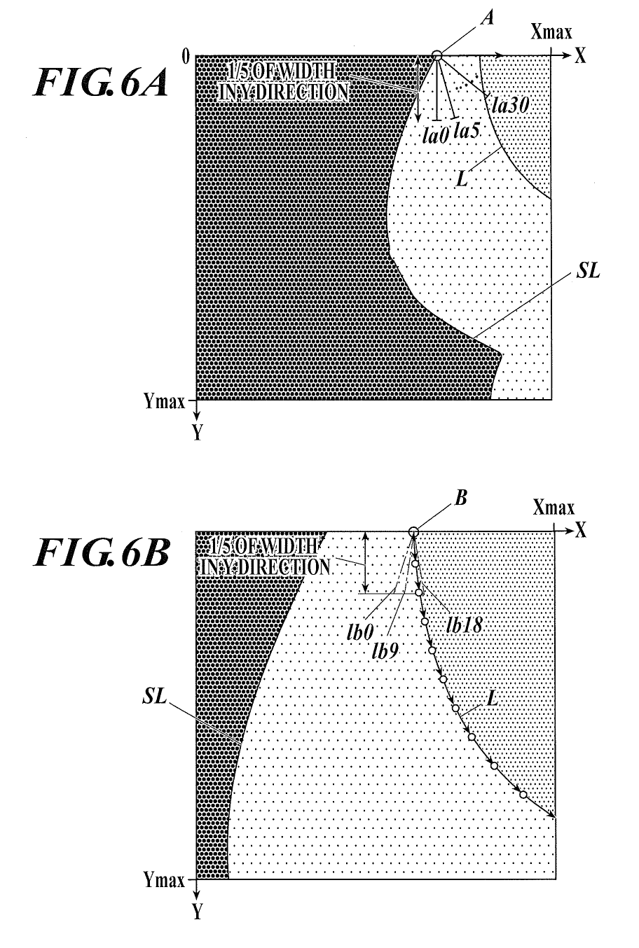

First, the control section 21 performs filtering with a Prewitt filter to each pixel of the breast image as a target pixel. Hereinafter, as shown in FIG. 6A, the position of each pixel in the breast image after filtering is expressed by a coordinate (X, Y) with X axis which is a horizontal direction of breast in the breast image and Y axis which is a direction orthogonal to the horizontal direction. The pixel value of the coordinate (X, Y) in the breast image after the filtering is expressed by V (X, Y). The coordinates of the image end in the X and Y directions are respectively expressed as Xmax and Ymax. The detection of pectoralis major muscle line is performed to the breast image after the filtering was performed.

Next, the control section 21 determines a search start point of pectoralis major muscle line L. Specifically, the control section 21 sets a start reference point to a coordinate A which is located several pixels below the coordinate S(0)(position of the image end of Y coordinate 0 in the skin line SL) having the maximum V(X, 0). Then, the control section 21 performs the following processing for searching for a search start point B of the pectoralis major muscle line L while shifting the reference point by 1 pixel in the X direction from the coordinate A.

As shown in FIG. 6A, around each reference point, search lines la0 to la30 each having a length of ⅕ of the width in the Y direction of the breast image are set by 1 degree for the range of 0 to −30 degrees of the angle with respect to the Y direction. Next, average values of pixel values on the search lines la0 to la30 are calculated. After the average values of pixel values on the search lines la0 to la30 are calculated for all the reference points, the reference point of search line having the largest average value is determined as the pectoralis major muscle line search start point B.

In a case where the pectoralis major muscle line search start point B is close to the image right end (Xmax), for example, in a case where the pectoralis major muscle line search start point B is located within 10 pixels from the right end, the control section 21 determines that the pectoralis major muscle line L does not exist. In a case where the largest calculated average value is smaller than a predetermined threshold, the control section 21 determines that the pectoralis major muscle line L does not exist. FIG. 6B shows an enlarged view around the pectoralis major muscle line search start point B.

Next, the control section 21 searches for the pectoralis major muscle line L. Specifically, as shown in FIG. 6B, search lines lb0 to lb18 each having a length of ⅕ of width in Y direction of the breast image are set by 1 degree in the range of ±9 degrees of the angle with respect to the Y direction on the basis of the pectoralis major muscle line search start point B as a base point. Next, average values of pixel values on search lines lb0 to lb18 are calculated. The search line lbn (n indicates one of integers of 0 to 18) having the largest average value is detected as the pectoralis major muscle line L.

Similar processing is performed on the basis of the base point located 1/10 of width in Y direction from the pectoralis major muscle line search start point B. Thereafter, similar processing is further performed based on the point, as a base point, of 1/10 of width in Y direction from the previous base point. Similar processing is repeated until reaching to the image end, and thus the pectoralis major muscle line L is detected.

In a case where the largest average value of the search lines lb0 to lb18 is smaller than a predetermined threshold, the control section 21 determines the line as a vague pectoralis major muscle line L. In a case where there are two or more base points where the largest average value of search lines lb0 to lb18 is larger than a threshold, secondary approximate curve is drawn from the base points, and the curve is detected as the pectoralis major muscle line L. In a case where there is one base point or less where the largest average value of search lines lb0 to lb18 is larger than the threshold, the above processing is executed by shifting the pectoralis major muscle line search start point B by 1 pixel in the Y direction.

When the pectoralis major muscle line L is detected, the control section 21 sets the region sandwiched between the detected pectoralis major muscle line L and the skin line SL to be a tentative breast region (step S103). In a case where the pectoralis major muscle line L does not exist, the control section 21 sets the region surrounded by the skin line SL and the image end closer to the chest wall to be a tentative breast region.

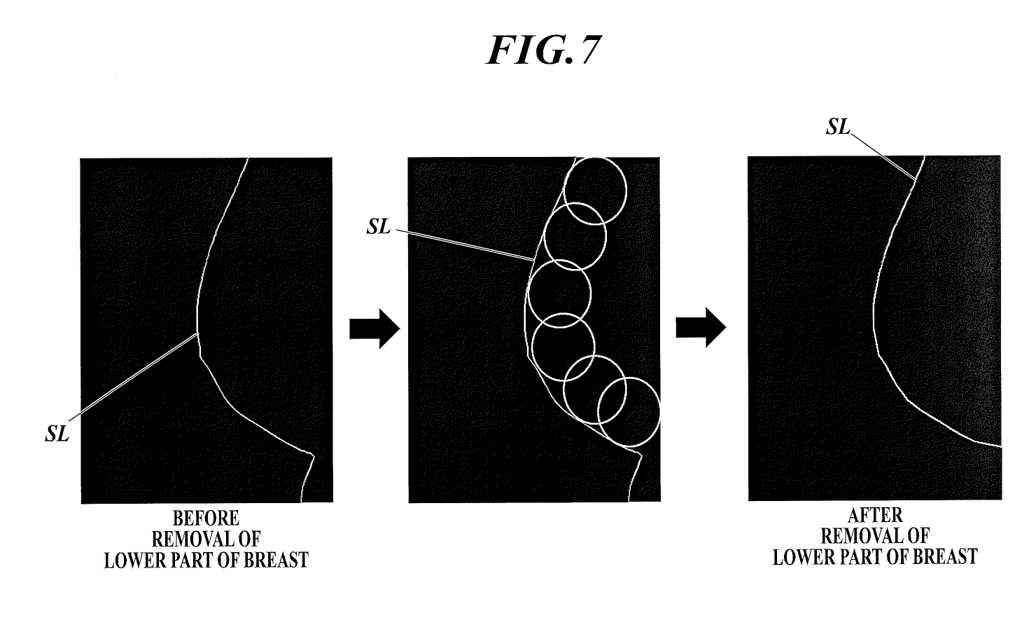

The control section 21 removes a breast lower part from the tentative breast region (step S104). For example, as shown in FIG. 7, circles having a predetermined size are drawn so as to be adjacent to the inner side (chest wall side) of the skin line SL in the breast image, and the region outside the line connecting the outer side (skin line SL side) of the drawn circles is removed. The region after the removal is extracted as the breast region. The pixel values of the removed region are converted into minimum brightness values.

When the breast region extraction processing is finished, the control section 21 shifts the processing to step S2 in FIG. 4, and performs the mammary gland region extraction processing (step S2).

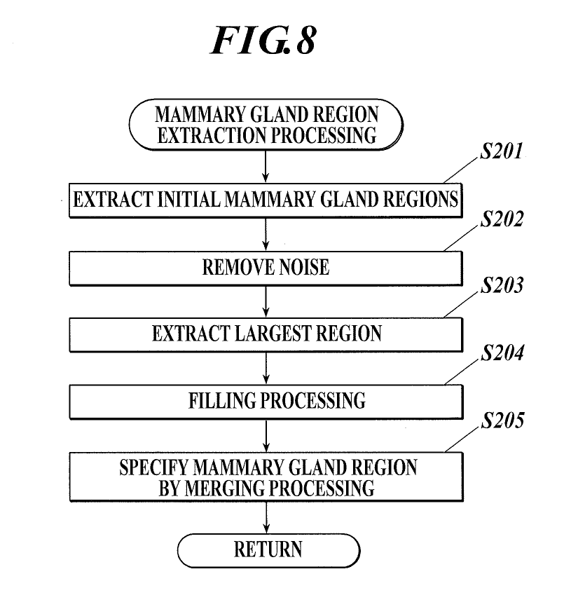

FIG. 8 shows a flow chart of the mammary gland region extraction processing. The mammary gland region extraction processing is executed by a cooperation of the control section 21 and a program stored in the storage section 25.

First, the control section 21 extracts initial mammary gland regions (step S201).

In step S201, the breast image is reduced in size and then subjected to dynamic range compression. A histogram is created for pixel values of the breast region in the breast image after the size reduction and the dynamic range compression. A threshold as a first reference value is determined on the basis of the created histogram, and threshold processing is performed by using the determined threshold to extract the initial mammary gland regions. If the created histogram has a single peak, the threshold is determined by the maximum entropy method. If the histogram has two or more peaks, the threshold is determined by the discriminant analysis method. In the breast region, each region (high brightness region) having the pixel value which is equal to or larger than the determined threshold is extracted as the initial mammary gland region.

In step S201, the control section 21 adjusts the threshold determined from the histogram on the basis of the mammary gland region extraction parameter which is set in the setting parameter file 252.

Next, the control section 21 removes noise (step S202).

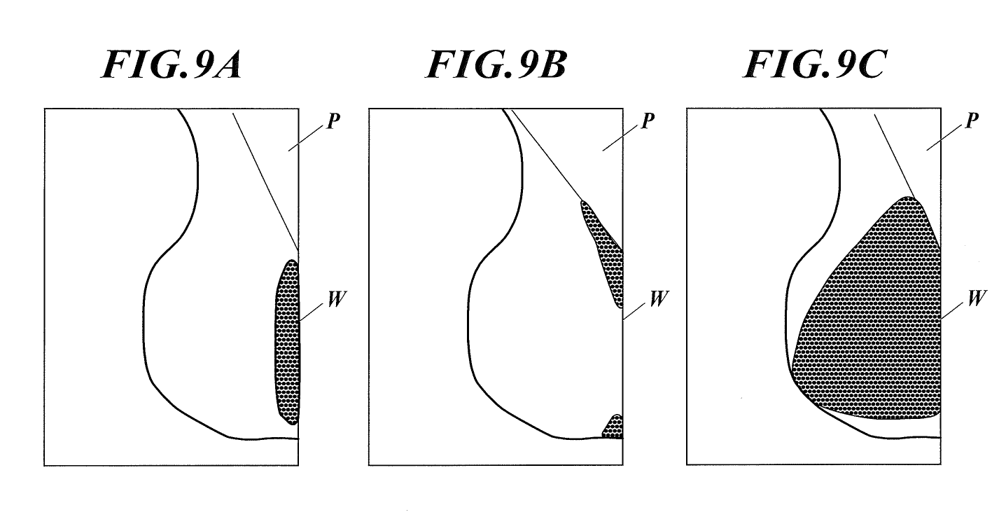

Specifically, among the extracted initial mammary gland regions, the control section 21 removes (deletes), as noise, the initial mammary gland region having the area smaller than a predetermined threshold (for example, region having the area smaller than five pixels). Among the extracted initial mammary gland regions, as shown in FIG. 9A, the control section 21 also removes, as noise, the initial mammary gland region which is adjacent to the chest wall W and has the area which is equal to or smaller than a predetermined reference area (for example, 30% or less of the area of breast region). As shown in FIG. 9B, the initial mammary gland region which is adjacent to the pectoralis major muscle region P and has the area which is equal to or smaller than a predetermined reference area (for example, 30% or less of the area of breast region) is removed as noise. As shown in FIG. 9C, the region having the area larger than the predetermined reference area is not noise, and thus, not removed even when the region is adjacent to the chest wall W or the pectoralis major muscle region P.

Next, the control section 21 extracts the largest region from among the initial mammary gland regions (step S203).

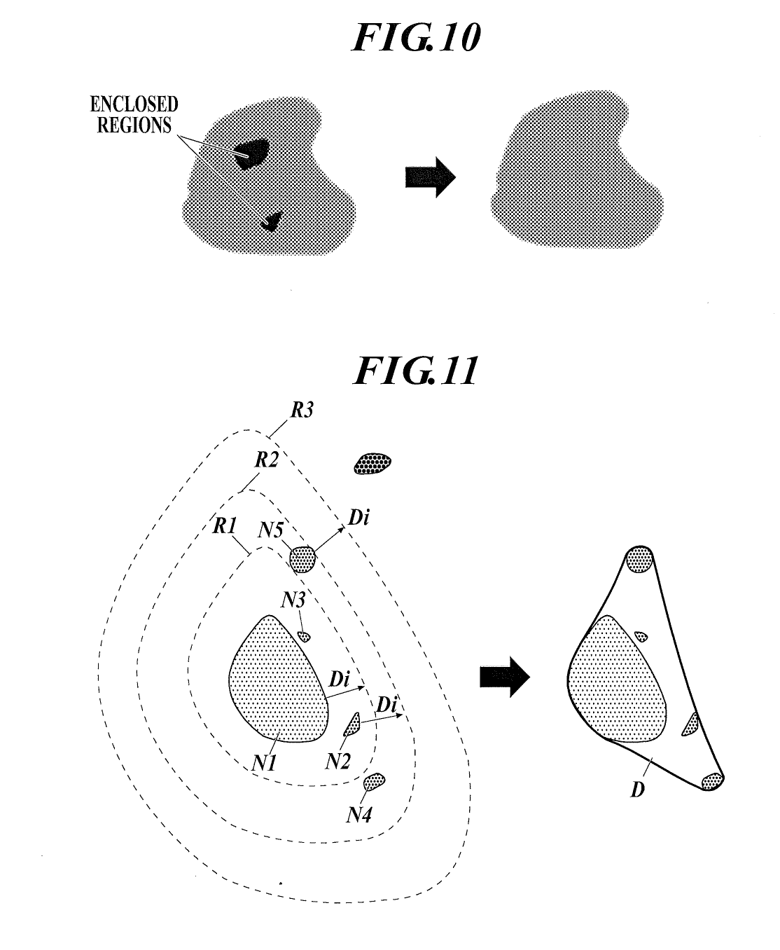

Next, the control section 21 performs filling processing for closing enclosed regions included in the initial mammary gland regions as shown in FIG. 10 (step S204).

The control section 21 performs the merging processing to specify a final mammary gland region (step S205), and shifts the processing to step S3 in FIG. 4.

FIG. 11 shows the summary of merging processing. As shown in FIG. 11, in the merging processing, the control section 21 first determines whether there is another initial mammary gland region in a region R1 obtained by enlarging the largest region (N1 in FIG. 11) extracted in step S203 by the distance Di from the outline thereof. If there is an initial mammary gland region, the initial mammary gland region is determined as a merging target. For example, the regions N2 and N3 are merging targets in FIG. 11. Next, the control section 21 determines whether there is another initial mammary gland region, which is not included in the region R1, in a region R2 obtained by enlarging the region R1 into a similar shape by the distance Di from the outermost initial mammary gland region (region farthest from the largest region) among the initial mammary gland regions which were determined as the merging targets. If there is an initial mammary gland region, the initial mammary gland region is added to the merging target. For example, in FIG. 11, the regions N4 and N5 are added as the merging targets. The above processing is repeated until another initial mammary gland region is not newly found in the region obtained by enlarging the region R1 into a similar shape by the distance Di from the outermost initial mammary gland region among the initial mammary gland regions which were determined as the merging targets. When there is no more initial mammary gland region to be added as the merging target, the outer ring of the initial mammary gland regions as the merging targets is obtained, and the region inside the obtained outer ring is specified as the final mammary gland region. The initial mammary gland regions located outside the outer ring are removed as noise. The outer ring may be obtained by the dynamic contour method (SNAKES method, Level Set method, for example) or a closed convex hull may be obtained. A smooth outer ring can be obtained by the dynamic contour method. On the other hand, the closed convex hull has a merit of being obtained by comparatively easy calculation.

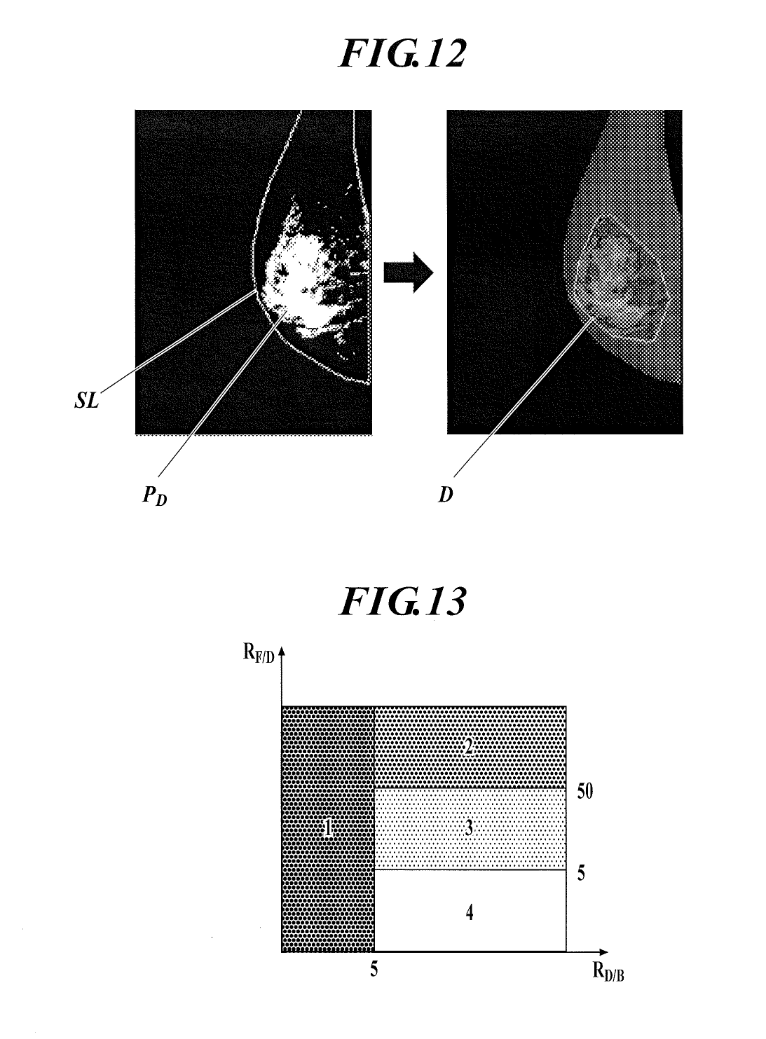

FIG. 12 shows an example of initial mammary gland regions and a result of the merging processing performed to the initial mammary gland regions. In FIG. 12, the white region PD indicates the initial mammary gland regions and the region D indicates the mammary gland region specified by the merging processing.

In the conventional image analysis, high brightness region has been obtained from the breast region by threshold processing and the high brightness region has been regarded as the mammary gland region. However, depending on the setting of threshold, there is a case where a region actually having a mammary gland region is not regarded as the mammary gland region. Doctors determine a mammary gland region by supplementing the mammary gland region by the spread of mammary gland regions around a papilla in the image analysis result on the basis of the knowledge that mammary glands spread from a papilla as a base point. Thus, in the embodiment, the mammary gland region is determined to be the region specified in the merging processing of initial mammary gland regions so that the determination is compatible with the determination of doctors.

When the extraction of mammary gland region is finished, the control section 21 shifts the processing to step S3 in FIG. 4, and performs fat region extraction processing for extracting a fat region in the mammary gland region (step S3).

In step S3, for example, the control section 21 creates histogram of pixel values in the mammary gland region, determines a threshold as a second reference value on the basis of the created histogram, and performs threshold processing by using the determined threshold to extract the fat region in the mammary gland region. The threshold is determined by the maximum entropy method in a case where the created histogram has a single peak, and the threshold is determined by the discriminant analysis method in a case where the histogram has two or more peaks. In the mammary gland region, the region (low brightness region) having pixel values which are equal to or smaller than the determined threshold is extracted as a fat region in the mammary gland region. The first and second reference values satisfy the relationship “first reference value>second reference value”. In step S3, the control section 21 adjusts the threshold calculated from the histogram on the basis of the fat region extraction parameter of the setting parameter file 252.

Alternatively, the region other than the initial mammary gland regions in the mammary gland region may be extracted as the fat region in the mammary gland region.

Next, the control section 21 calculates respective areas of the extracted breast region, mammary gland region and fat region in the mammary gland region, and acquires an index indicating a lesion missing risk on the basis of the calculated areas (step S4).

Mammography screening has been widely and generally known for breast cancer screening. The mammography screening enables detection of minute lesions and thus enables early detection of breast cancer. However, the detection of lesion is difficult in a case of patients having high density mammary glands since the mammary glands and lesions (lumps or the like) are expressed by same degrees of brightness values in breast images obtained in the mammography screening. On the other hand, since fat regions are expressed by brightness values which are different from those of lesions on the breast image, the lesions can be detected more easily as there are more fat regions.

Thus, in step S4, the index indicating lesion missing risk when reading the breast image is calculated on the basis of the areas of extracted breast region, mammary gland region and fat region in the mammary gland region.

As the index indicating lesion missing risk, for example, at least one of the following (A) to (C) is obtained.

(A) Respective areas of breast region, mammary gland region and fat region in the mammary gland region

(B) RD/B=(area D of mammary gland region/area B of breast region)×100 RF/D=(area F of fat region in the mammary gland region/area D of mammary gland region)×100

(C) Score obtained by biaxially evaluating the value of (B)

Each of the areas of breast region, mammary gland region and fat region in the mammary gland region can be calculated on the basis of the number of pixels in the region. The score of the above (C) is calculated as follows:

(1) First, as shown in FIG. 13, coordinate space (graph) is generated with the horizontal axis of RD/B and vertical axis of RF/D, and the coordinate space is divided into the following four score regions.

Region of Score 1: region where RD/B is equal to or smaller than a threshold 1 (first threshold, here, 5). That is, the region where the ratio of mammary gland region to the breast region is slight and the risk of missing the lesion is low.

Region of Score 2: region where RD/B exceeds the threshold 1, and RF/D is equal to or larger than a threshold 2 (second threshold, here, 50). That is, the region where the ratio of mammary gland region to the breast region is large to some degree, but the ratio of fat region in the mammary gland region to the mammary gland region is also comparatively large, and thus the risk of missing lesion is not so high.

Region of Score 3: region where RD/B exceeds the threshold 1 and RF/D is smaller than the threshold 2 and equal to or larger than a threshold 3 (third threshold) (threshold 2>threshold 3). That is, the ratio of mammary gland region to the breast region is large to some degree, and the ratio of fat region in the mammary gland region to the mammary gland region is not so large, and thus, the risk of missing lesion is high.

Region of Score 4: region where RD/B exceeds the threshold 1 and RF/D is smaller than the threshold 3. That is, the ratio of mammary gland region to the breast region is large to some degree, and the fat region in the mammary gland region to the mammary gland region is small, and thus, the risk of missing lesion is very high.

(2) Next, the RD/B and RF/D are calculated, and the calculated values of RD/B and RF/D are plotted on the graph, and the score of the region including the plotted points is the index indicating the lesion missing risk when reading the received breast image.

The thresholds 1 to 3 are score determination parameters of the setting parameter file 252.

In the above embodiment, the index indicating the lesion missing risk is classified to scores 1, 2, 3 and 4 in the order from the region having lower risk of missing lesion on the above-mentioned graphs. However, the index is not limited to this, and may be classified to scores A, B, C and D. The index may be classified to fatty, mammary gland scattered, non-uniform high density and high density in the order from the region having lower risk of missing lesion.

Next, the control section 21 associates the patient information, examination information, the values of the used parameter and such like with the acquired index indicating lesion missing risk, transmits them as lesion missing risk information to the image display apparatus 3 by the communication section 24 (step S5), and ends the lesion missing risk information acquisition processing.

In the image display apparatus 3, when the communication section 34 receives the lesion missing risk information from the image processing apparatus 2, the control section 31 stores the received missing risk information in the image DB 351 so as to be associated with the breast image from which the missing risk information was acquired. In the image display apparatus 3, when examination information of an image as a display target is selected via the operation section 32 from breast images stored in the image DB 351, the control section 31 controls the display section 33 to display the breast image of the selected examination from the image DB 351 and the index indicating the lesion missing risk when reading the breast image.

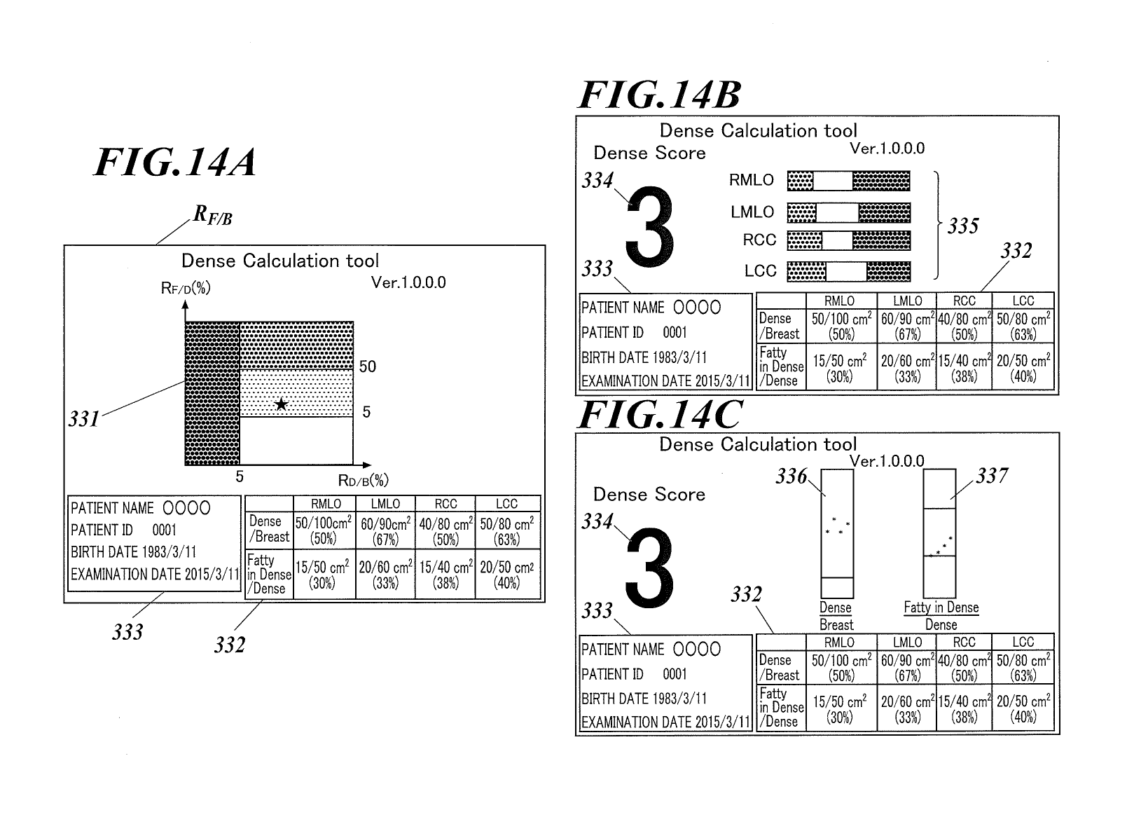

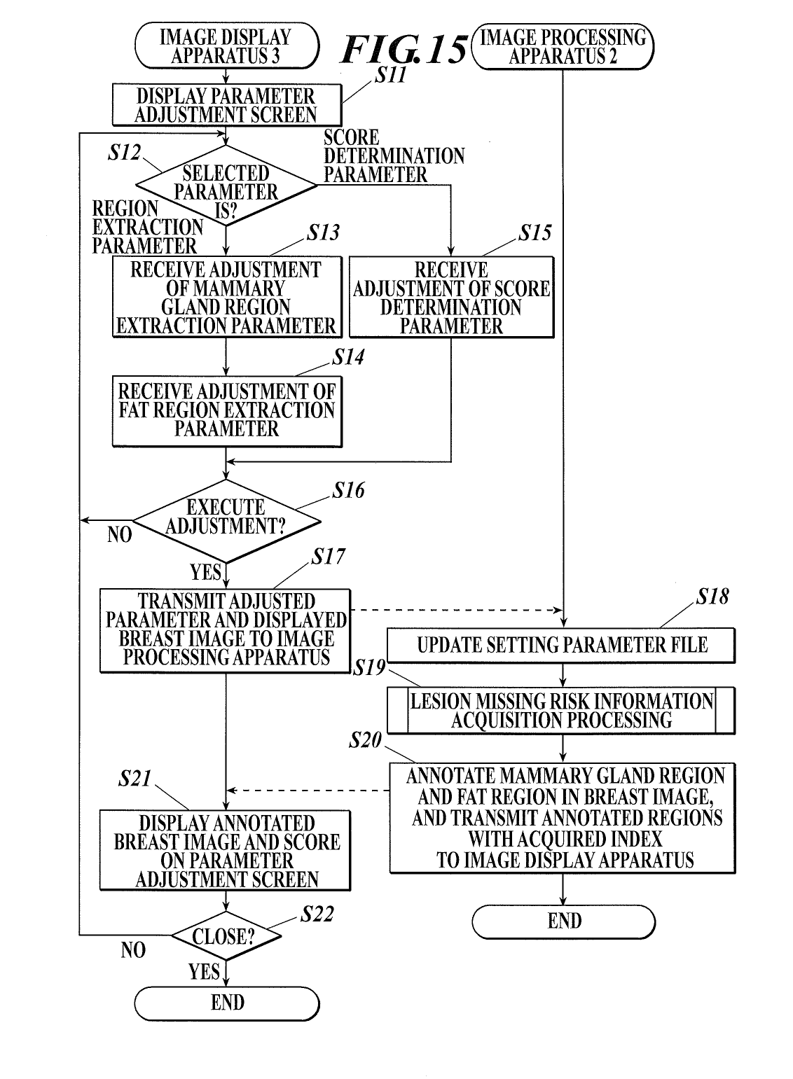

FIG. 14A shows an example of display manner of the index indicating lesion missing risk displayed on the image display apparatus 3. In the example shown in FIG. 14A, on the graph indicating the regions of scores of the above (C), there is displayed a graph 331 plotting coordinates of RD/B and RF/D (coordinates having highest score among left and right MLO images and CC images), and a table 332 indicating “mammary gland region area D/breast region area B”, RD/B, “fat region area F in mammary gland region/mammary gland region area D” and RF/D of each of the left and right MLO images and CC images acquired by the examination. The patient information and the examination information 333 are also displayed together.

In an example shown in FIG. 14A, the graph 331 plotting the coordinates of RD/B and RF/D is displayed on the graph indicating the regions of scores of (C). Thus, the user can easily grasp the degree of lesion missing risk when reading the displayed breast image.

FIG. 14B shows another example of display manner of index indicating lesion missing risk displayed on the image display apparatus 3. In the example shown in FIG. 14B, there are displayed the score (largest score among left and right MLO images and CC images) 334 of the above (C), bar graph 335 intuitively indicating the ratio of the mammary gland region in the breast region and the ratio of the fat region in mammary gland region for each of the left and right MLO images and CC images acquired by the examination, the above-mentioned table 332, patient information and examination information 333. In the bar graph 335, the entire graph indicates the breast region, the region of low density dots and white region indicates the mammary gland region, and the region of low density dots indicates the fat region in the mammary gland.

In the example shown in FIG. 14B, there are displayed the score of (C) and the bar graph 335 indicating the ratio of mammary gland region in breast region and the ratio of fat region in mammary gland region for each of the left and right MLO images and CC images acquired by the examination. Thus, the user can easily grasp the degree of lesion missing risk when reading each breast image. The user can also easily compare the ratios of mammary gland region in breast region and fat region in the mammary gland region of four types of breast images.

FIG. 14C shows another example of display manner of index indicating lesion missing risk displayed on the image display apparatus 3. In the example shown in FIG. 14C, there are displayed the score 334 (largest score of left and right MLO images and CC images) of above (c), bar graph 336 plotting the respective values of RD/B of the left and right MLO images and CC images acquired in the examination, bar graph 337 plotting the values of RF/D, the above table 332, patient information and the examination information 333. The horizontal line in the bar graph 336 indicates the threshold 1, and the * indicates the plot points of the RD/B values of RMLO, LMLO, RCC and LCC in the order from left. The horizontal line in the bar graph 337 indicates the thresholds 2 and 3. The * indicates the plot points of RF/D values of RMLO, LMLO, RCC and LCC in the order from left.

In the example shown in FIG. 14C, there are displayed the score of (C), bar graph 336 plotting the RD/B values of left and right MLO images and CC images acquired in the examination, and bar graph 337 plotting the RF/D values. Thus, the user can easily grasp the degree of lesion missing risk when reading the breast image. The user can also easily compare the RD/B and RF/D values of four types of breast images.

In response to a request from the image display apparatus 3, adjustment can be performed to the setting values specific to the facility for the region extraction parameter (mammary gland region extraction parameter for adjusting the first reference value, and fat region extraction parameter for adjusting the second reference value) and the score determination parameter (parameters indicating the first threshold, second threshold and third threshold) which are used in the above lesion missing risk information acquisition processing.

FIG. 15 shows a flowchart of parameter adjustment processing executed in the image display apparatus 3 and the image processing apparatus 2. The parameter adjustment processing is executed when an instruction to adjust parameter is input via the operation section 32 of image display apparatus 3, and the parameter adjustment processing achieves the function as a first adjustment section and a second adjustment section. The processing in the image display apparatus 3 shown in FIG. 15 is executed in cooperation between the control section 31 and the program stored in the storage section 35. The processing in the image processing apparatus 2 is executed in cooperation between the control section 21 and the program stored in the storage section 25.

The control section 31 of image display apparatus 3 displays a parameter adjustment screen 338 on the display section 33 (step S11).

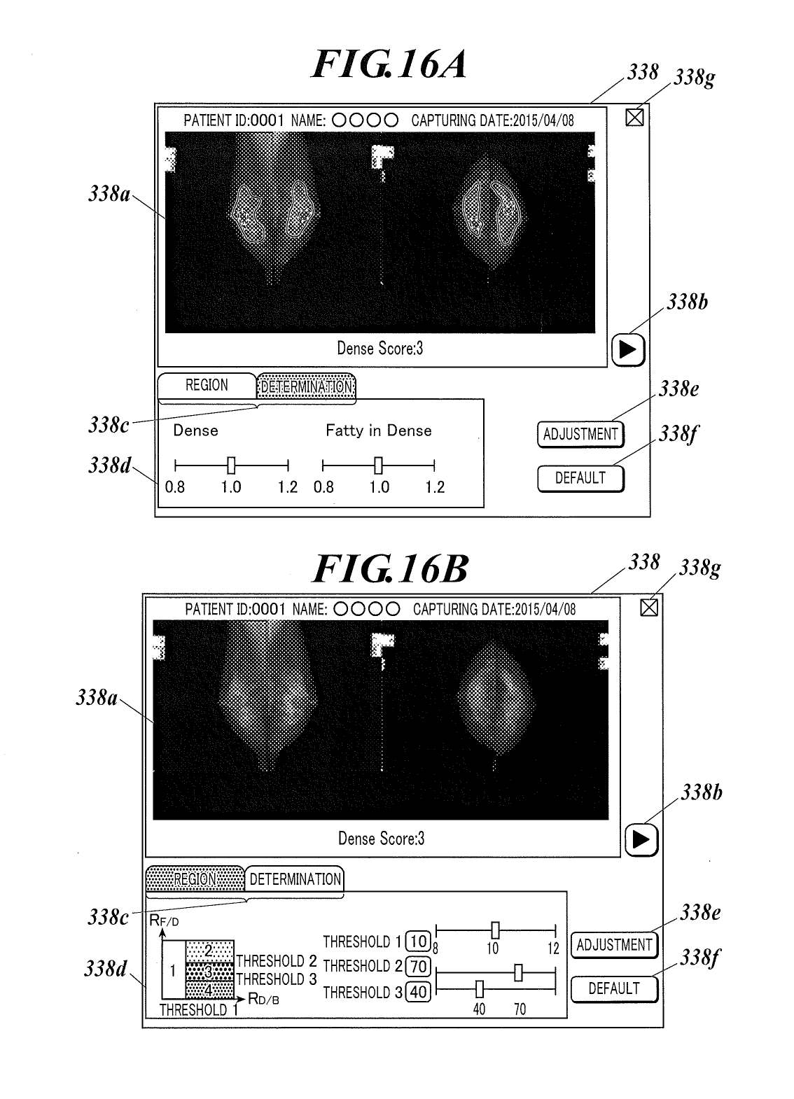

FIGS. 16A and 16B show an example of parameter adjustment screen 338. As shown in FIGS. 16A and 16B, the parameter adjustment screen 338 is provided with a breast image display field 338a for displaying the breast image used in the parameter adjustment, a change button 338b for changing the breast image used in the parameter adjustment, an item selection tab 338c for selecting the item of parameter which is the adjustment target, a parameter adjustment field 338d displaying slide bars for parameter adjustment, an adjustment button 338e, a default button 338f and a close button 338g. In the initial state of the parameter adjustment screen 338, the breast image of the latest examination date and time is displayed in the breast image display field 338a, for example, and the breast image can be switched in the descending order of examination date and time by pressing the change button 338b. In the initial state, the item selection tab 338c is selecting the region extraction parameter (see FIG. 16A), and the tab can be switched to selecting the score determination parameter by pressing the item selection tab 338c of “determination” (see FIG. 16B).

The control section 31 then determines whether the item selection tab 338c is selecting the region extraction parameter or score determination parameter in the parameter adjustment screen 338 (step S12).

If it is determined that the region extraction parameter is selected (step S12: region extraction parameter), the control section 31 receives adjustment of the mammary gland region extraction parameter via the operation section 32 and adjustment of the fat region extraction parameter (adjustment of slide bar of the parameter adjustment field 338d or pressing of the default button 3380 (steps S13 and S14), and shifts the processing to step S16. In a case where the default button 338f is pressed via the operation section 32, it is possible to adjust default values of both the mammary gland region extraction parameter and the fat region extraction parameter.

On the other hand, if it is determined that the score determination parameter is selected (step S12: score determination parameter), the control section 31 receives the adjustment of score determination parameter via the operation section 32 (adjustment of slide bar of the parameter adjustment field 338d or pressing of the default button 3380 (step S15), and shifts the processing to step S16. When the default button 338f is pressed via the operation section 32, the score determination parameter can be adjusted to the default value.

In step S16, the control section 31 determines whether the adjustment button 338e was pressed via the operation section 32 (step S16). If it is not determined that the adjustment button 338e was pressed (step S16; NO), the control section 31 returns the processing to step S12.

On the other hand, if it is determined that the adjustment button 338e was pressed (step S16; YES), the control section 31 transmits the adjusted parameter value and the breast image displayed on the breast image display field 338a to the image processing apparatus 2 via the communication section 34, and requests parameter setting (step S17).

In the image processing apparatus 2, when the communication section 24 receives the parameter setting request, the control section 21 updates the value of setting parameter file 252 stored in the storage section 25 by the received parameter (step S18). The control section 21 uses the received breast image and parameter to execute the lesion missing risk information acquisition processing (step S19), annotates the extracted mammary gland region and the fat region in the mammary gland region on the breast image, and transmits them with the acquired index indicating lesion missing risk (for example, score) to the image display apparatus 3 via the communication section 24 (step S20).

In the image display apparatus 3, when the communication section 34 receives the annotated breast image and index indicating lesion missing risk from the image processing apparatus 2, the control section 31 displays the received breast image and index indicating lesion missing risk on the breast image display field 338a (step S21).

Next, the control section 31 determines whether the close button 338g was pressed via the operation section 32 (step S22). If it is not determined that the close button 338g was pressed (step S22; NO), the control section 31 returns the processing to step S12. If it is determined that the close button 338g was pressed (step S22; YES), the control section 31 ends the parameter adjustment processing.

### Modification Example

Next, a modification example of the embodiment will be described.

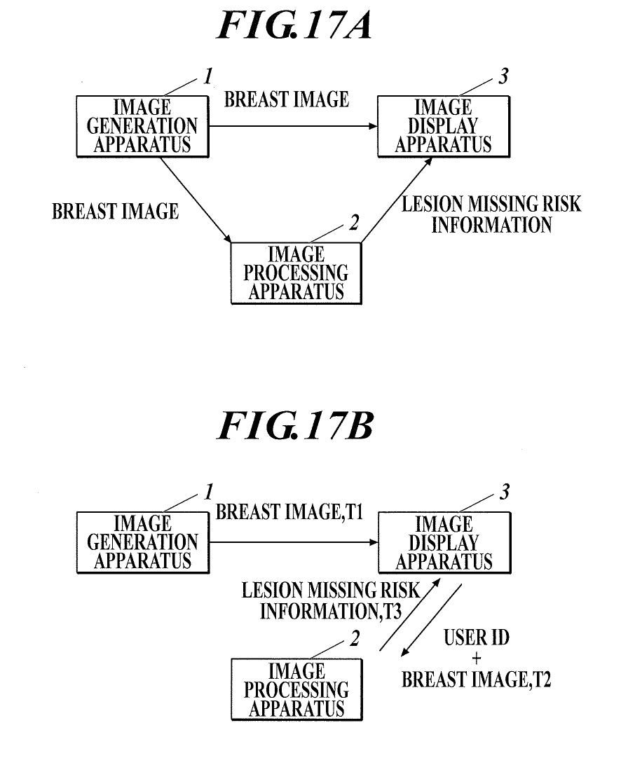

The above embodiment has been described by taking, as an example, a case where the setting parameter specific to facility is stored in the setting parameter file 252 in order to perform diagnosis based on unified criteria as a diagnosis department of the facility. In this case, as shown in FIG. 17A, after the breast image was generated in the image generation apparatus 1, the breast image is transmitted to the image processing apparatus 2 and the image display apparatus 3, the lesion missing risk information acquisition processing is performed by referring to the setting parameter file 252 in the image processing apparatus 2, and the acquired lesion missing risk information is transmitted to the image display apparatus 3. Then, the image display apparatus 3 stores the received lesion missing risk information in the image DB 351 so as to be associated with the breast image, and when the examination of the display target is selected via the operation section 32, the control section 31 displays the selected breast image and index indicating lesion missing risk on the display section 33.

In the modification example, there is described an example where the parameter can be set for each doctor (user) of the diagnosis department of the facility.

The configurations of the medical image system 100 and the apparatuses in the modification example are similar to those of the embodiment. However, in the modification example, the storage section 25 of the image processing apparatus 2 stores the setting parameter file 252 for each user. That is, in the storage section 25, setting parameter files 252 for users are stored so as to be associated with user IDs of the respective users. In the storage section 25, the user IDs and passwords are also stored so as to be associated with each other for users allowed to access the medical image system 100.

Hereinafter, the difference of the modification example from the embodiment in the operation of medical image system 100 will be described.

As shown in FIG. 17B, when the breast image is generated, the image generation apparatus 1 transmits the breast image to the image display apparatus 3 (T1). When the breast image is received from the image generation apparatus 1, image display apparatus 3 stores the received breast image in the image DB 351.

In the image display apparatus 3, when a user ID and a password are input via the operation section 32 and the breast image of display target is selected, the control section 31 performs user authentication, and thereafter transmits the selected breast image and user ID to the image processing apparatus 2 via the communication section 34 to request the execution of lesion missing risk information acquisition processing (T2). In the image processing apparatus 2, when the communication section 24 receives the request to execute the lesion missing risk information acquisition processing, the control section 21 reads out the setting parameter file 252 stored so as to be associated with the received user ID, executes the lesion missing risk information acquisition processing by using the received breast image and the read setting parameter file 252, and transmits the acquired lesion missing risk information to the image display apparatus 3 by the communication section 24 (T3). In the image display apparatus 3, when the communication section 34 receives the lesion missing risk information, the control section 31 displays the selected breast image and the index indicating lesion missing risk thereof on the display section 33.

In the image display apparatus 3, after the user ID and password are input via the operation section 32 and user authentication is performed, when an instruction of parameter adjustment is input via the operation section 32, the control section 31 executes the parameter adjustment processing. In step S17 of the parameter adjustment processing, when the control section 31 transmits the adjusted parameter and the breast image displayed on the breast image display field 338a to the image processing apparatus 2 via the communication section 34, the control section 31 also transmits the user ID of log-in user. In the image processing apparatus 2, the setting parameter file 252 stored so as to be associated with the received user ID is updated by the received parameter value.

As described above, in the modification example, the parameter is set for each doctor (user) of the diagnosis department of the facility, and thus, it is possible to provide the index indicating the lesion missing risk corresponding to the criteria of each user.

As described above, according to the medical image system 100, the control section 21 of the image processing apparatus 2 extracts a breast region from the breast image obtained by X-ray imaging of breast, extracts a mammary gland region from the breast region, and extracts a fat region in the mammary gland region from the mammary gland region. Then, the control section 21 calculates respective areas of breast region, mammary gland region and fat region in the mammary gland region, on the basis of the calculated areas, acquires an index indicating the lesion missing risk when reading the breast image, and transmits the index to the image display apparatus 3 with the communication section 24. In the image display apparatus 3, the received index indicating the lesion missing risk is displayed together with the breast image on the display section 33.

Accordingly, it is possible to provide an index indicating a lesion missing risk which is objective and compatible with conventional methods for determining a lesion missing risk by a doctor.

For example, the control section 21 acquires the respective areas of the breast region, mammary gland region and fat region in the mammary gland region as the index indicating lesion missing risk when reading the breast image. Accordingly, it is possible to provide an index indicating a lesion missing risk which is objective and compatible with conventional methods for determining a lesion missing risk by a doctor.

For example, the control section 21 calculates the area ratio of mammary gland region to breast region and the area ratio of fat region in the mammary gland region to mammary gland region, and acquires the calculated ratios as an index indicating lesion missing risk when reading the breast image. Accordingly, it is possible to provide an index indicating a lesion missing risk which is objective and compatible with conventional methods for determining a lesion missing risk by a doctor.

For example, the control section 21 generates a graph having the area ratio (RD/B) of mammary gland region to breast region as a horizontal axis and the area ratio (RF/D) of fat region in mammary gland region to mammary gland region as a vertical axis, and divides the region of generated graph into four regions which are a region where the RD/B is equal to or smaller than a first threshold, a region where RD/B exceeds the first threshold and RF/D is equal to or larger than a second threshold, a region where RD/B exceeds the first threshold and RF/D is smaller than the second threshold and equal to or larger than a third threshold, and a region where RD/B exceeds the first threshold and RF/D is smaller than the third threshold. The control section 21 acquires, as an index indicating lesion missing risk when reading the breast image, a score corresponding to the region including the coordinates of RD/B and RF/D calculated from the breast image. Accordingly, it is possible to provide an index indicating a lesion missing risk which is objective and compatible with conventional methods for determining a lesion missing risk by a doctor and which enables the doctor to easily understand the level of the risk.

Since it is possible to adjust region extraction parameter and score determination parameter from the parameter adjustment screen 338, the index can be more compatible with user's criteria.

When extracting the mammary gland region, the control section 21 extracts, as initial mammary gland regions, the regions in the breast region which have brightness values exceeding a first reference value and are equal to or larger than a predetermined size, obtains an outer ring of initial mammary gland regions within a predetermined range, and extracts the region inside the obtained outer ring as a final mammary gland region. Thus, the index can be compatible with doctor's visual determination of the mammary gland region.

The indexes indicating lesion missing risk are displayed together for respective four types of breast images which are left and right MLO images and left and right CC images. Thus, the user can grasp the lesion missing risks for respective breast images and compare the lesion missing risks.

The above description of embodiment is a preferred example of the present invention, and the present invention is not limited to this.

For example, in the embodiment, the image processing apparatus 2 and the image display apparatus 3 are separate apparatuses. However, the functions of the two apparatuses may be achieved by a single apparatus. That is, a program may be stored in a storage section of an apparatus so that the above functions are achieved by cooperation between the program and a control section such as a CPU, the program being a program for making a computer function as a target region extraction section, a first extraction section, a second extraction section, an acquisition section and a display section.

The embodiment has been described by taking, as an example, a case where the target site is a breast and an index indicating lesion missing risk is acquired from the breast image. However, the present invention is not limited to this, and can be applied to medical images of other target sites. For example, there is a phenomenon that, in a chest radiograph, a lung having pneumonia has high brightness in the lung field, which makes it difficult to see a lung cancer when the lung cancer exists. Thus, it is useful to apply the present invention to the chest radiograph, and present an index indicating lesion missing risk for attention.

The above embodiment has been described by taking, as an example, a case of using a non-volatile memory such as hard disk and semiconductor as for the computer readable medium to store the programs according to the present invention. However, the present invention is not limited to this example. As other computer readable medium, portable recording mediums such as a CD-ROM can be used. Further, as the medium for providing program data according to the present invention via a communication circuit, a carrier wave can also be used.

As for the other detailed configurations and detailed operations of apparatuses and sections forming the medical image system, modifications can be appropriately made within the scope of the present invention.

What is claimed is:

1. A medical image system, comprising:
a target region extraction section which extracts a target region from a medical image obtained by X-ray imaging of a target site;
a first extraction section which extracts an initial region from the target region, the initial region having a brightness value which is equal to or larger than a first reference value;
a second extraction section which extracts a region having a brightness value that is equal to or smaller than a second reference value from a region including the initial region in the target region;
an acquisition section which calculates areas of the target region, the region including the initial region and the region extracted by the second extraction section, and acquires an index regarding a lesion based on the calculated areas; and
a display section which displays the acquired index regarding the lesion.

2. The medical image system according to claim 1, wherein the index regarding the lesion is an index indicating a lesion missing risk.

3. The medical image system according to claim 1, wherein the first reference value is a brightness value which is larger than the second reference value.

4. The medical image system according to claim 1, further comprising a noise removal section which removes, as noise, an initial region that meets a predetermined condition among the initial region extracted by the first extraction section, wherein
the second extraction section extracts a region having a brightness value which is equal to or smaller than the second reference value from a region including all the initial region from which the noise is removed by the noise removal section, and
the acquisition section calculates, as the area of the region including the initial region, an area of the region including all the initial region from which the noise is removed by the noise removal section.

5. The medical image system according to claim 4, wherein the noise removal section removes, as noise, an initial region which is located out of a predetermined range with respect to at least one initial region selected from among a plurality of initial regions.

6. The medical image system according to claim 5, wherein the noise removal section determines, as a merging target, an initial region located within a distance Di from a largest initial region among the plurality of initial regions, and repeats processing of adding an initial region to the merging target, the initial region to be added being located inside a region obtained by enlarging the largest initial region by the distance Di from an outermost initial region among the initial region determined as the merging target, and, when there is no initial region to be added to the merging target, the noise removal section obtains an outer ring of the largest initial region and the initial region determined as the merging target and removes an initial region located outside the obtained outer ring as noise.

7. The medical image system according to claim 4, wherein the noise removal section removes an initial region as noise from among a plurality of initial regions, the initial region being smaller than a predetermined area.

8. The medical image system according to claim 4, wherein the noise removal section removes an initial region as noise from among a plurality of initial regions, the initial region being located at a predetermined position in the target region and equal to or smaller than a reference area.

9. The medical image system according to claim 1, wherein the acquisition section acquires, as the index regarding the lesion, the areas of the target region, the region including the initial region and the region extracted by the second extraction section.

10. The medical image system according to claim 1, wherein the acquisition section calculates an area ratio of the region including the initial region to the target region and an area ratio of the region extracted by the second extraction section to the region including the initial region, and acquires the calculated area ratios as the index regarding the lesion.

11. The medical image system according to claim 1, wherein the acquisition section generates a graph having a horizontal axis which is an area ratio (R_{D/B}) of the region including the initial region to the target region and a vertical axis which is an area ratio (R_{F/D}) of the region extracted by the second extraction section to the region including the initial region, and divides a region of the graph into four regions which are a region where the R_{D/B} is equal to or smaller than a first threshold, a region where the R_{D/B} exceeds the first threshold and the R_{F/D} is equal to or larger than a second threshold, a region where the R_{D/B} exceeds the first threshold and the R_{F/D} is smaller than the second threshold and equal to or larger than a third threshold, and a region where the R_{D/B} exceeds the first threshold and the R_{F/D} is smaller than the third threshold, and the acquisition section acquires, as the index regarding the lesion, a score corresponding to a region which includes coordinates of the R_{D/B} and the R_{F/D} calculated from the medical image.

12. The medical image system according to claim 11, further comprising a first adjustment section which adjusts the first threshold, the second threshold and the third threshold.

13. The medical image system according to claim 1, further comprising a second adjustment section which adjusts the first reference value and the second reference value.

14. The medical image system according to claim 1, wherein
the target site is a breast,
the target region extraction section extracts a breast region from a breast image which is obtained by X-ray imaging of the breast,
the first extraction section extracts an initial mammary gland region by extracting a region which has a brightness value being equal to or larger than the first reference value from the breast region, and
the second extraction section extracts a fat region in a mammary gland region by extracting a region which has a brightness value being equal to or smaller than the second reference value from the mammary gland region including the initial mammary gland region.

15. The medical image system according to claim 14, wherein the display section displays indexes regarding the lesion together with each other, the indexes being calculated from four types of breast images which are left and right MLO images and left and right CC images.

16. A non-transitory computer readable recording medium storing a program to cause a computer to function as:
a target region extraction section which extracts a target region from a medical image obtained by X-ray imaging of a target site;
a first extraction section which extracts an initial region from the target region, the initial region having a brightness value which is equal to or larger than a first reference value;
a second extraction section which extracts a region having a brightness value that is equal to or smaller than a second reference value from a region including the initial region in the target region;
an acquisition section which calculates areas of the target region, the region including the initial region and the region extracted by the second extraction section, and acquires an index regarding a lesion based on the calculated areas; and
a display section which displays the acquired index regarding the lesion.
